(19) United States
(12) Patent Application Publication
(10) Pub. No.: US 2002/0188938 A1
(43) Pub. Date: Dec. 12, 2002

(54) System and method for providing application software for a peripheral device

(76) Inventors: Mimi Chu Dong, Greeley, CO (US); Thomas R. Mitchell, Laporte, CO (US); Gary Carlton, Greeley, CO (US); Robert D. Bushey, Fort Collins, CO (US); John L. Reed, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/878,564

(22) Filed: Jun. 11, 2001

(51) Int. Cl. G06F 9/445

(52) U.S. Cl. 717/174

(57) ABSTRACT

A system and method for providing application software for a peripheral device to be installed in a computer system. The application software is rendered into a memory module coupled to the peripheral device. When the peripheral device is attached to the computer, the operating system of the computer queries the peripheral device. Responsive to the query, the peripheral device is operable to upload the application software into the computer system from the memory module.

### BACKGROUND OF THE INVENTION

1. Technical Field of the Invention

The present invention generally relates to peripheral devices operable with computers. More particularly, and not by way of any limitation, the present invention is directed to a system and method for providing application software for a peripheral device coupled to a computer.

2. Description of Related Art

Several computer applications typically involve the use of one or more peripheral devices such as, e.g., printers, scanners, digital cameras, and the like. It is well known that such peripheral devices require special software known as device driver software for operating them in conjunction with the computers to which they are coupled. Also, additional software such as customer usage application software, customer support diagnostic software, etc. may be required for executing device-specific applications and diagnostics under computer control.

Typically, software required for the peripheral devices may be bundled with the operating system of the computers. For example, it is well known that Microsoft® Windows® operating system is bundled with a large number of device drivers for various peripheral devices including, e.g., printers from several manufacturers. More increasingly, however, such software is provided by the manufacturers of the peripheral devices on separate portable media such as compact discs (CDs) and floppy disks.

Although these conventional approaches to providing application software for the peripheral devices have been generally useful, they are beset with several shortcomings and deficiencies, nonetheless. For example, when the application software is bundled with an operating system, the manufacturers of peripheral devices are forced to time their products and associated application software updates so as to match the product release/revision cycles of the operating system. It should be apparent to those skilled in the art that this condition poses a significant inconvenience to the peripheral device manufacturers for a variety of reasons. Further, from the customer standpoint, the choice of peripheral devices is limited to the drivers bundled with the operating system.

On the other hand, many disadvantages exist also where separate portable media are utilized for providing the application software. For instance, users are typically required to go through a cumbersome device and software installation process using the CD or floppy disks. Inasmuch as the graphic user interface and interactive dialog-box-based sessions have made the installation procedure somewhat easier, the users still need to know various aspects of their computers and associated system requirements, e.g., type and/or version of the operating system, processor type and capabilities, available memory and fixed storage capacity, graphics capabilities and display monitor specifications, type of input/output (I/O) port used for connecting the peripheral device, etc. Furthermore, the users have to safeguard the separate portable media for future use or use with different computers.

### SUMMARY OF THE INVENTION

Accordingly, the present invention is directed to a system and method for providing application software for a peripheral device to be installed in a computer system. The application software is rendered into a memory module coupled to the peripheral device. When the peripheral device is attached to the computer, the operating system of the computer queries the peripheral device. Responsive to the query, the peripheral device is operable to upload the application software into the computer system from the memory module.

### BRIEF DESCRIPTION OF THE DRAWINGS

A more complete understanding of the present invention may be had by reference to the following Detailed Description when taken in conjunction with the accompanying drawings wherein:

FIG. 1 depicts a block diagram of an exemplary system for providing application software for a peripheral device to be installed in a computer system in accordance with the teachings of the present invention;

FIG. 2 is a block diagrammatic representation of exemplary application software operable to be uploaded from a memory module coupled to a peripheral device; and

FIG. 3 depicts a flow chart of the various steps involved in an exemplary method for providing application software for a peripheral device to be installed in a computer system in accordance with the teachings of the present invention.

### DETAILED DESCRIPTION OF THE DRAWINGS

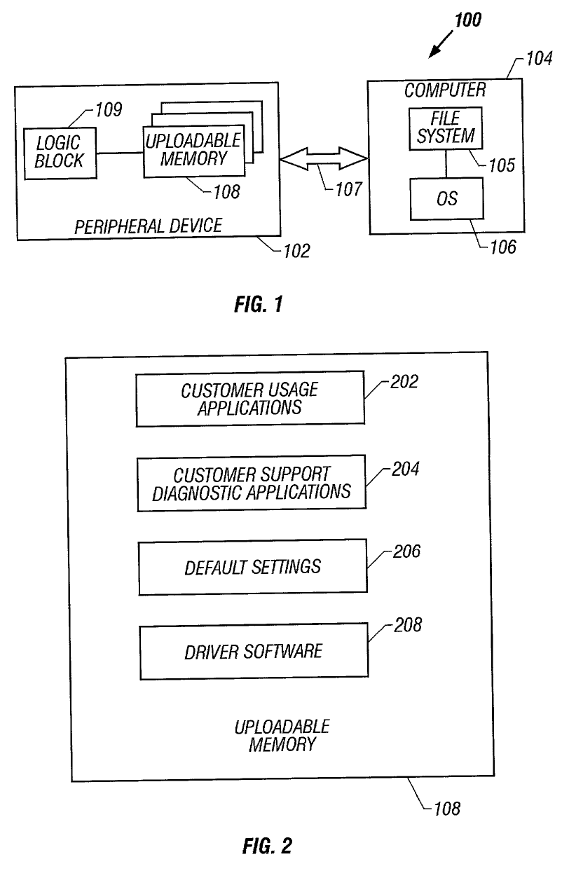

In the drawings, like or similar elements are designated with identical reference numerals throughout the several views thereof, and the various elements depicted are not necessarily drawn to scale. Referring now to FIG. 1, depicted therein is an exemplary system 100 for providing application software for a peripheral device 102 to be installed in a computer system 104 in accordance with the teachings of the present invention. Those skilled in the art should recognize upon reference hereto that the peripheral device 102 may be comprised of any known or hitherto unknown peripheral device capable of requiring appropriate application software for proper functioning in conjunction with the computer system 104. Some of the presently preferred exemplary embodiments of the present invention accordingly include, for instance, printers, scanners, digital cameras, and the like.

Similarly, the computer system 104 having an operating system 106 may be comprised of any known or hitherto unknown computer architecture such as, e.g., desktop personal computers, laptop and notebook computers, handheld and palmtop computers adaptable to accept peripheral devices, high performance computing platforms, etc. Further, the computer system 104 may be based on any processor architecture as well. Accordingly, the operating system 106 may be selected from the group comprised of, for instance, any UNIX-based operating system such as, e.g., HP-UX®, AIX®, Linux®, Solaris®, etc., Microsoft® Windows®, Windows® NT®, as well as Macintosh® MacOS® operating system.

As is well known in the art, the operating system 106 is central to the functioning of the computer system 104 and any peripheral devices connected thereto. It is also well known that the operating system 106 is operable to organize application software files associated with the peripheral devices into an appropriate file system 105 once such software is loaded into the computer system 104 upon the installation of the peripheral devices. As has been pointed out in the Background section of the present patent application, numerous disadvantages exist in the current methodology for providing application software for peripheral devices to be installed in a computer system, e.g., computer system 104.

In accordance with the teachings of the present invention, one or more uploadable memory modules 108 are integrated with the peripheral device 102, wherein the application software for the peripheral device 102 is programmed appropriately for use with different types of operating systems, processor architectures and computer systems. Preferably, the memory modules 108 are comprised of read/write (R/W)—capable nonvolatile memory (NVM) such as, e.g., flash read-only memory (ROM), electrically programmable ROM (EPROM), electrically erasable PROM (EEPROM), nonvolatile RAM (NVRAM), and the like. Whereas a separate logic block 109 may also be provided with the peripheral device 102 for coordinating the software uploading process in conjunction with the operating system 106 when suitable control signals are effectuated via path 107 upon initially attaching the peripheral device 102 to the computer system 104, such functionality may be integrated, at least in part, with the uploadable memory module 108 itself. Further, those skilled in the art should recognize that path 107 may be implemented by means of various cabling media as well as wireless, radio, infrared, and other media.

FIG. 2 is a block diagrammatic representation of the exemplary application software operable to be uploaded from the uploadable memory module 108 coupled to the peripheral device 102. In a presently preferred embodiment of the present invention, one or more customer usage application programs 202, one or more customer support diagnostic applications 204, default user settings 206, device driver software 208, and other related installation software (not explicitly shown) are provided as part of the uploadable application software. With respect to printers, for example, customer usage application programs 202 may comprise creative printing software modules operable with a select printer for printing professional flyers, newsletters, brochures, for creating personalized greeting cards, frames, for designing stationery, certificates, stickers, labels, and for creating t-shirts, making patterns such as quilts, cross stitch, et cetera. In similar fashion, photo albums, cropping editors, different autoexposure setting modules, and the like comprise the customer usage application programs 202 for digital cameras.

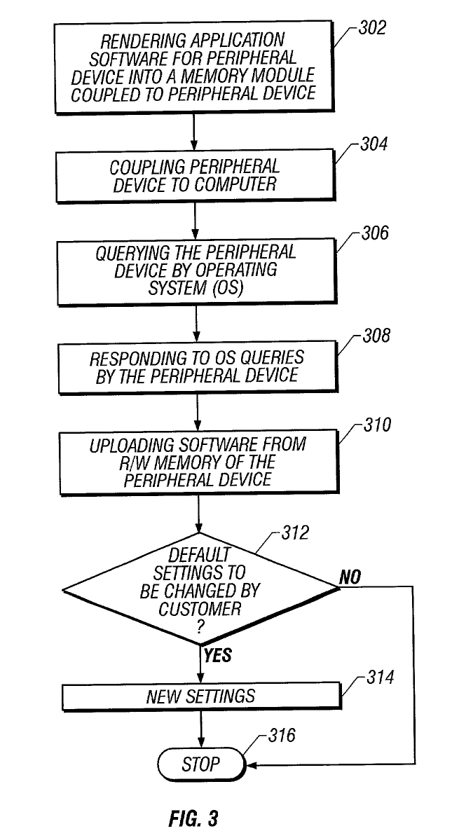

Referring now to FIG. 3, depicted therein is a flow chart of the various steps involved in an exemplary method for providing application software for a peripheral device (e.g., the peripheral device 102 shown in FIG. 1) to be installed in a computer system (e.g., the computer system 104 also shown in FIG. 1) in accordance with the teachings of the present invention. The application software for the peripheral device is preferably rendered into one or more memory modules coupled to the peripheral device, whereby appropriate code compatible with various operating systems and computer platforms is programmed (step 302). Those skilled in the art should readily recognize that such memory modules having applicable code may be provided by the manufacturer of the peripheral device itself, by a third-party, or by the computer manufacturer. Further, the application software in the memory module may be encoded, compressed, encrypted, or otherwise manipulated.

Upon coupling the peripheral device to the computer by a user (step 304), the operating system of the computer is operable to sense the presence of new hardware either automatically or when the computer is reset. Thereafter, the operating system queries the peripheral device to identify itself and the software it supports, including type, version, revision, release, and other indicia relating thereto (step 306). The memory module or a separate logic block associated with the peripheral device appropriately responds to the operating system query (step 308). In conjunction with the querying process, the operating system or a separate logic block associated therewith is further operable to make a determination whether the application software provided in at least one of the memory modules of the peripheral device is compatible with the computer system, including its processor architecture, the operating system, etc.

Upon determining that the memory module includes applicable compliant application software, control signals indicative of an instruction to the peripheral device are then generated to initiate an upload operation. Responsive to the control signals (e.g., handshake signals), the peripheral device uploads the applicable compliant application software into the computer system, which then becomes organized by the operating system into its file system.

Continuing to refer to FIG. 3, upon successful uploading of the application software, a user dialog box or session may be established via a display monitor associated with the computer system for determining whether the user is desirous of changing at least a portion of the default settings (decision block 312). If not, the uploading process terminates subsequently (step 316). Otherwise, new settings may be selected (step 314) prior to termination.

In a further aspect, the present invention is directed to a computer-readable medium operable in association with a computer system to which a peripheral device is to be coupled. Preferably, the computer-readable medium is operable to carry a sequence of instructions which, when executed in conjunction with the computer system, causes the steps described hereinabove in particular detail to be performed. Essentially, upon coupling the peripheral device to the computer system by a user, the peripheral device is queried by an operating system executing on the computer system. A determination is made thereafter if a memory module associated with the peripheral device includes application software compatible with the computer system, including its processor architecture and the operating system. If so, control signals signifying an instruction to the peripheral device to upload the application software into the computer system are generated. Responsive to the instruction signals, appropriate application software is loaded into the computer system.

Based upon the foregoing Detailed Description, it should be readily apparent that the present invention provides a simple yet effective solution for providing application software for a peripheral device to be installed in a computer system. Several advantages of the present invention should be apparent. First, the need for having the appropriate driver software and usage application software bundled with an operating system is obviated. Accordingly, the manufacturers of peripheral devices can independently roll out their products without being tied with the operating system's revisions or releases. Also, because the need for portable media such as CDs and floppy disks carrying the requisite application software is obviated, the installation Asetup in accordance with the teachings of the present invention becomes substantially less cumbersome. Moreover, it is no longer necessary to keep track of such portable media, which are prone to loss, misplacement, etc. Since the portable media carrying application software are not required, savings in product cost may be realized. Furthermore, the customer or user does not have to know the type/version of OS is installed on his/her computer and other related system requirements. In addition, because of the localization of application software with the product, inventory management at computer stores and distribution centers becomes more manageable.

What is claimed is:

1. A method for providing application software for a peripheral device to be installed in a computer system, comprising the steps of:
rendering said application software into a memory module coupled to said peripheral device;
upon coupling said peripheral device to said computer system by a user, querying said peripheral device by an operating system executing on said computer system; and
responsive to said querying step, uploading said application software into said computer system from said memory module coupled to said peripheral device.

2. The method of claim 1, wherein said step of rendering said application software into a memory module comprises the step of programming a flash read-only memory (ROM) module with said application software.

3. The method of claim 1, wherein said application software comprises at least one of customer usage application software, customer support diagnostic application software, driver software and at least one default setting with respect to said peripheral device.

4. The method of claim 1, wherein said step of rendering said application software into a memory module comprises the step of programming a nonvolatile memory (NVM) module with said application software.

5. The method of claim 1, wherein said step of rendering said application software into a memory module comprises the step of programming an electrically programmable read-only memory (EPROM) module with said application software.

6. The method of claim 1, wherein said step of rendering said application software into a memory module comprises the step of programming an electrically erasable programmable read-only memory (EEPROM) module with said application software.

7. The method of claim 1, wherein said step of rendering said application software into a memory module comprises the step of programming a nonvolatile random access memory (NVRAM) module with said application software.

8. The method of claim 1, wherein said step of querying said peripheral device comprises the step of making a determination by said operating system whether said application software is compatible with said operating system.

9. The method of claim 1, wherein said step of querying said peripheral device comprises the step of making a determination by said operating system whether said application software is compatible with said computer system.

10. The method of claim 1, wherein said step of querying said peripheral device by an operating system is performed in association with Microsoft® Windows® operating system.

11. The method of claim 1, wherein said step of querying said peripheral device by an operating system is performed in association with a UNIX-based operating system.

12. The method of claim 1, wherein said step of querying said peripheral device by an operating system is performed in association with Linux® operating system.

13. The method of claim 1, wherein said step of querying said peripheral device by an operating system is performed in association with Macintosh® MacOS® operating system.

14. The method of claim 1, wherein said step of querying said peripheral device by an operating system is performed in association with Solaris® operating system.

15. The method of claim 1, wherein said step of querying said peripheral device by an operating system is performed in association with AIX® operating system.

16. The method of claim 1, wherein said step of querying said peripheral device by an operating system is performed in association with HP-UX® operating system.

17. The method of claim 1, wherein said peripheral device is selected from the group consisting of: a printer, a digital camera and a scanner.

18. A system for providing application software for a peripheral device to be installed in a computer system, comprising:
a memory module associated with said peripheral device, said memory module including said application software;
means associated with said computer system for querying said peripheral device when said peripheral device is operably coupled to said computer system; and
means in said peripheral device operable to upload said application software into said computer system from said memory module based on control signals provided to said peripheral device from said computer system.

19. The system of claim 18, wherein said memory module comprises one of a flash ROM module, an EPROM module, an EEPROM module and an NVRAM module.

20. The system of claim 18, wherein said application software comprises at least one of customer usage application software, customer support diagnostic application software, driver software and at least one default setting with respect to said peripheral device.

21. The system of claim 18, wherein said peripheral device is selected from the group consisting of: a printer, a digital camera and a scanner.

22. A computer-readable medium operable in association with a computer system to which a peripheral device is to be coupled, said computer-readable medium carrying a sequence of instructions which, when executed in conjunction with said computer system, causes the following steps to be performed:
upon coupling said peripheral device to said computer system by a user, querying said peripheral device by an operating system executing on said computer system;
determining whether a memory module associated with said peripheral device includes application software compatible with at least one of said computer system and said operating system, said application software for operating said peripheral device in association with said computer system; and
responsive to said determining step, uploading said application software into said computer system.

23. The computer-readable medium of claim 22, wherein said memory module is selected from the group consisting of: a flash ROM module, an EPROM module, an NVRAM module and an EEPROM module.

24. The computer-readable medium of claim 22, wherein said peripheral device is selected from the group consisting of: a printer, a digital camera and a scanner.

25. The computer-readable medium of claim 22, wherein said operating system is selected from the group consisting of a Unix-based operating system, Microsoft® Windows® operating system, Windows® NT® operating system and Macintosh® MacOS® operating system.

26. The computer-readable medium of claim 22, wherein said application software comprises at least one of customer usage application software, customer support diagnostic application software and driver software.

27. The computer-readable medium of claim 22, wherein said application software comprises at least one default setting with respect to said peripheral device.
